(19) United States
(12) Patent Application Publication
(10) Pub. No.: US 2015/0237886 A1
(43) Pub. Date: Aug. 27, 2015

(54) PREMIX FOR BROILER FEED AND A METHOD OF FEEDING A BROILER TO PRODUCE DHA AND EPA ENRICHED CHICKEN

(71) Applicants: Martin Gregory CLUNIES, Branchton (CA); Ian James ROSS, Ayr (CA); Bruce Ezra SCHUMANN, Cambridge (CA)

(72) Inventors: Martin Gregory CLUNIES, Branchton (CA); Ian James ROSS, Ayr (CA); Bruce Ezra SCHUMANN, Cambridge (CA)

(21) Appl. No.: 14/191,826

(22) Filed: Feb. 27, 2014

(51) Int. Cl. A23K 1/16; A23L 1/315; A23K 1/14; A23K 1/18; A23K 1/10

(52) U.S. Cl. CPC A23K 1/164; A23K 1/1826; A23K 1/103; A23K 1/14; A23L 1/315; A23V 2002/00

(57) ABSTRACT

A premix for broiler feed and a method of feeding a broiler that produces DHA and EPA enriched chicken while avoiding or reducing negative effects to the taste, colour, texture, aroma, pH and shelf life which may be significant enough to make the chicken unacceptable to consumers. One embodiment of the method involves feeding a broiler over about 14 to 21 days with a broiler feed supplemented with the premix. The premix includes marine-sourced docosahexaenoic acid (DHA) and eicosapentaenoic acid (EPA), plant-sourced alpha-linolenic acid (ALA) and organic selenium. The broilers are fed until their total DHA, EPA and ALA intakes are in a certain range. The broilers are then slaughtered and processed into chicken products. This may result in chicken products with an enrichment of omega-3 EFAs in the range of about 239.9 to about 472.7 milligrams of total omega-3 per 100 grams of total edible meat.

### FIELD OF THE APPLICATION

The present application relates to a premix for broiler feed and a method of feeding a broiler, and more particularly, a premix for broiler feed and a method of feeding a broiler that results in DHA and EPA enriched chicken.

### BACKGROUND OF THE APPLICATION

Omega-3 Essential Fatty Acids (EFAs) are fatty acids that are important to human health but which cannot be constructed within the human body and therefore must be obtained by diet. Most omega-3 EFAs come from marine and plant sources. Eicosapentaenoic Acid (EPA) and Docosahexaenoic Acid (DHA) come primarily from marine sources, such as cold-water fishes, for example, salmon. Alpha-Linolenic Acid (ALA) comes primarily from plant sources, such as nuts, seeds, or vegetables.

Most people, especially North Americans, do not consume enough omega-3 EFAs to meet their daily nutritional needs. Beyond consuming enough omega-3 EFAs, the ratio of omega-3 EFAs to omega-6 EFAs consumed has also been found to affect human health. Desirable ratios of omega-3 to omega-6 are in the 1:1 to 1:5 range. However, many food products such as milk and other dairy products contain omega-3 to omega-6 ratios of 1:5 or higher. North American diets as a result are typically too heavily weighted to omega-6 EFAs, which may contribute to a number of health problems including heart disease.

Various foods have been enriched with omega-3 EFAs, such as bread, eggs and milk. Flaxseed is the most common source for omega-3 EFA enrichment since it is comparatively better tasting than marine sources of omega-3 EFAs. Many people find a fishy taste in non-fish foods unpleasant. But while flax is high in ALA, it is not as rich in DHA and EPA. Evidence has shown that greater health benefits come from the consumption of DHA and EPA than from the consumption of ALA. Nevertheless, marine-sourced omega-3 EFA enrichment of foods, for example meat products, has not been successful due to the poor taste of the enriched food product, as well as due to negative effects on the texture, colour, aroma, pH and shelf life of the enriched food product.

Enriching chicken may present additional challenges due to poultry being more sensitive to off-flavours than other types of meats, such as pork, and due to chicken having larger differences in the ratio of muscle tissue to fat tissue between various muscle groups (e.g. chicken breasts are very lean by nature whereas chicken thighs are much fattier), as compared to pork for example. These larger differences may make commercially successful omega-3 EFA enrichment of chicken more difficult since the ratio of muscle tissue to fat tissue affects omega-3 EFA enrichment.

Selenium is a mineral in human and animal diets that also affects health as a component of the antioxidant enzyme system. In particular, selenium is a component of the enzyme glutathione peroxidase which neutralizes toxic peroxides that are formed during the conversion of body fat to energy. Absent neutralization, these peroxides can damage cell components and may cause a range of health problems, including cancer. Selenium is also a component of more than 20 other functional proteins in the body, most of which have some type of protective function.

Many humans are deficient in selenium, to a large extent because the majority of livestock feed grains and soybeans are being grown in regions where the soil is low in selenium. This causes selenium deficiencies in the animals consuming the feed and consequently in humans consuming the animal products.

Accordingly, there remains a need for improvements in enriched food products.

### BRIEF SUMMARY OF THE INVENTION

According to one aspect, the present invention provides a method of feeding a broiler which results in DHA and EPA enriched chicken while avoiding or reducing negative effects to the taste, colour, texture, aroma, pH and shelf life which are significant enough to make the chicken unacceptable to consumers. According to another aspect, the present invention provides chicken products produced according to the claimed methods. According to another aspect, the present invention provides a premix for broiler feed.

According to one embodiment, the present invention provides a method of feeding a broiler to produce chicken enriched with omega-3 Essential Fatty Acids (EFAs), the method comprising: feeding a broiler a feed; wherein the feed comprises marine-sourced docosahexaenoic acid (DHA) and eicosapentaenoic acid (EPA), plant-sourced alpha-linolenic acid (ALA), and organic selenium; and wherein the feeding provides a sufficient amount of the feed to the broiler until the broiler's total DHA intake is in the range of 0.06 g to 0.25 g, the broiler's total EPA intake is in the range of 0.31 g to 1.30 g, and the broiler's total ALA intake is in the range of 9.36 g to 42.25 g.

According to another embodiment, the present invention provides a premix for broiler feed comprising: marine-sourced docosahexaenoic acid (DHA) and eicosapentaenoic acid (EPA); plant-sourced alpha-linolenic acid (ALA); and organic selenium.

According to another embodiment, the present invention provides a method of feeding a broiler and producing chicken products including omega-3 Essential Fatty Acids (EFAs), the method comprising the steps of: feeding a broiler a feed supplemented with a premix; wherein the premix comprises marine-sourced docosahexaenoic acid (DHA) and eicosapentaenoic acid (EPA), plant-sourced alpha-linolenic acid (ALA), and organic selenium; and wherein the feeding provides a sufficient amount of the feed to the broiler until the broiler's total DHA intake is in the range of 0.06 g to 0.25 g, the broiler's total EPA intake is in the range of 0.31 g to 1.30 g, and the broiler's total ALA intake is in the range of 9.36 g to 42.25 g; slaughtering the broiler when the intake is within the recited ranges; and processing the broiler into one or more chicken products.

Other aspects and features according to the present application will become apparent to those ordinarily skilled in the art upon review of the following description of embodiments of the invention in conjunction with the accompanying figure.

### BRIEF DESCRIPTION OF THE DRAWINGS

Reference will now be made to the accompanying drawing which shows, by way of example, embodiments of the invention, and how they may be carried into effect, and in which:

FIG. 1 shows a flow chart of a method of feeding a broiler to produce chicken enriched with omega-3 EFAs according to an embodiment of the present invention; and

FIG. 2 shows a flow chart of a method of feeding a broiler and producing chicken products including omega-3 EFAs according to an embodiment of the present invention.

Like reference numerals indicate like or corresponding elements in the drawings.

### DETAILED DESCRIPTION OF THE EMBODIMENTS

Embodiments of the present invention are generally directed to premixes for broiler feed, methods of feeding a broiler that produce DHA and EPA enriched chicken while avoiding or reducing negative effects to the taste, colour, texture, aroma, pH and shelf life which are significant enough to make the chicken unacceptable to consumers, and chicken products produced according to the claimed methods.

One way which may make people more likely to meet their daily omega-3 EFA and selenium recommended dietary allowances is to enrich foods that people typically consume. While omega-3 EFAs are found in fish and other marine matter, it may be beneficial to enrich other foods that may be regularly consumed by humans, such as chicken.

EPA and DHA come primarily from marine sources, mainly fish that live in cold water. Fish high in omega-3 EFAs may include: salmon, trout, white tuna, king mackerel, sea bass, halibut, herring, oysters and sardines. Algae (or algal oil) is also high in EPA and DHA.

ALA comes primarily from plant sources. Plant sources high in omega-3s may include algae (algal oil), flaxseed, English walnuts, sunflower seeds, canola oil, safflower oil, soy, wheat germ, dark leafy greens such as kale, spinach, parsley, etc. and corn oil.

To increase the total omega-3 EFA concentrations in chicken cuts using marine-sourced DHA and EPA and plant-sourced ALA, it may be desirable to enrich the chicken to an enrichment of omega-3 EFAs in the range of about 239.9 to about 472.7 milligrams per 100 grams of total edible meat. It has been found that such a concentration may avoid negatively affecting the taste, colour, texture, aroma, pH and/or shelf life of the chicken to an extent that is commercially significant. Moreover, some consumers may find the enriched chicken according to embodiments of the invention more pleasant tasting than non-enriched chicken.

Feeding broilers omega-3 EFA-containing diets for longer durations and feeding higher dietary levels of omega-3 EFAs to broilers may increase omega-3 EFA concentrations in the chicken. A good predictor of omega-3 EFA profiles in broilers, without considering the duration of feeding, is to consider the absolute amount of omega-3 EFA consumed by the broiler. Longer durations of feeding to reach a certain absolute amount of omega-3 EFAs tends to reduce the variability in the omega-3 EFA profile between broilers, primarily because there may be greater variability in a broiler's feed intake across fewer days.

According to an embodiment, the levels of omega-3 EFAs among a plurality of broilers going to market at different times may be made more uniform by stopping the feeding of omega-3 EFAs to the broilers when the first broilers go to market or by feeding lower levels of omega-3 EFAs to the broilers for longer periods of time, or both. It will be appreciated that once the meat goes to a processing facility for slaughter and subsequent processing, it is usually too late to alter the omega-3 EFA enrichment levels of the meat.

According to an embodiment, a method for feeding a broiler to enrich chicken with omega-3 Essential Fatty Acids (EFAs) comprises feeding a broiler over a period of time, for example, in the range of about 14 days to about 21 days, with a feed that includes marine-sourced docosahexaenoic acid (DHA) and eicosapentaenoic acid (EPA), and plant-sourced alpha-linolenic acid (ALA). According to an embodiment, the broiler feed may have a ratio of omega-3 EFAs to omega-6 EFAs in the range of about 1.24:1 to about 1.26:1. According to another embodiment, the feeding may take place over less than 14 days; however, this may increase the probability that a broiler's intake falls outside of the recited ranges of omega-3 Essential Fatty Acid intakes in this disclosure which might result in off-flavours in the resultant chicken products.

According to an embodiment, a premix, such as a vitamin and mineral premix or feed supplement, comprising marine-sourced DHA and EPA, plant-sourced ALA, and organic selenium may be added to the feed. According to an embodiment, the premix may have a ratio of omega-3 EFAs to omega-6 EFAs in the range of about 1.24:1 to about 1.26:1. According to a further embodiment, the feed may contain marine-sourced DHA and EPA, plant-sourced ALA, and organic selenium without a premix having been added. According to a further embodiment, the premix or the feed may also include vitamin E. Generally, combining a premix according to an embodiment of the invention with a feed may allow persons feeding broilers greater flexibility and control over the proportion of omega-3 EFAs in the feed as compared to a feed that is sold already been enriched with omega-3 EFAs.

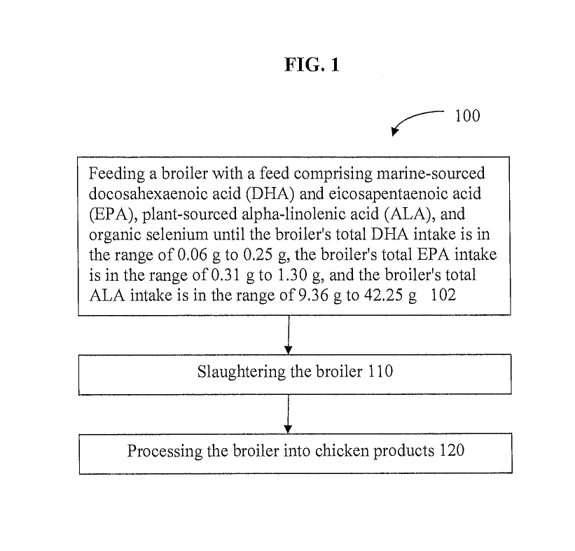

According to an embodiment as shown in FIG. 1, there is provided a method 100 comprising the steps of feeding a broiler with a feed comprising marine-sourced docosahexaenoic acid (DHA) and eicosapentaenoic acid (EPA), plant-sourced alpha-linolenic acid (ALA), and organic selenium, wherein the feeding provides a sufficient amount of the feed to the broiler until the broiler's total DHA intake is in the range of 0.06 g to 0.25 g, the broiler's total EPA intake is in the range of 0.31 g to 1.30 g, and the broiler's total ALA intake is in the range of 9.36 g to 42.25 g, as indicated by reference 110, slaughtering the broiler, as indicated by reference 120, which may be done at a processing facility, and processing the broiler into one or more chicken products, as indicated by reference 130, which also may be done at the processing facility. According to an embodiment of the method, the chicken products may have an enrichment of omega-3 EFAs in the range of about 239.9 to about 472.7 milligrams per 100 grams of total edible meat.

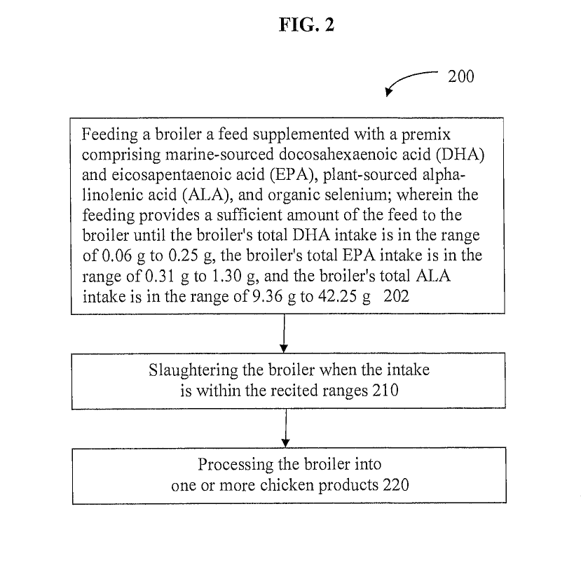

According to an embodiment as shown in FIG. 2, there is provided a method 200 of comprising the steps of feeding a broiler a feed supplemented with a premix comprising marine-sourced docosahexaenoic acid (DHA) and eicosapentaenoic acid (EPA), plant-sourced alpha-linolenic acid (ALA), and organic selenium wherein the feeding provides a sufficient amount of the feed to the broiler until the broiler's total DHA intake is in the range of 0.06 g to 0.25 g, the broiler's total EPA intake is in the range of 0.31 g to 1.30 g, and the broiler's total ALA intake is in the range of 9.36 g to 42.25 g, as indicated by reference 210, slaughtering the broiler when the intake is within the recited ranges, as indicated by reference 220, which may be done at a processing facility, and processing the broiler into one or more chicken products, as indicated by reference 230 which also may be done at the processing facility. According to an embodiment of the method, the chicken products may have an enrichment of omega-3 EFAs in the range of about 239.9 to about 472.7 milligrams per 100 grams of total edible meat.

According to an embodiment, organic selenium may also be included in the vitamin and mineral premix (or directly in the feed). There is evidence that including organic selenium in the premix (or directly in the feed) leads to higher concentrations of selenium in chicken cuts, unlike the use of inorganic selenium which tends to only benefit the live animal. This may be caused by more efficient transfer from the diet to the chicken muscle.

In addition to enriching the chicken, organic selenium may protect the tissues of the broiler from free radicals which occur as part of the oxidation process of the broiler both before and after the broiler has been slaughtered. The addition of organic selenium may therefore improve the shelf life of the omega-3 EFA enriched chicken products by stabilizing the essential fatty acids which enhances the taste and aroma of the chicken (as compared to when organic selenium is not used) by reducing the adverse effects of oxidation. If the essential fatty acids were not stabilized, the oxidation of the fatty acids may negatively affect the taste and odour of the chicken. As omega-3 enrichment (absent organic selenium) tends to negatively impact the shelf life of the chicken product, the improvement of the shelf life of the enriched chicken product from including organic selenium may be commercially advantageous. There is also evidence that selenium consumption has numerous health benefits for humans and animals, as discussed above. According to an embodiment of the invention, organic selenium may be included in the premix in a suitable proportion such that when the premix is mixed into the feed, organic selenium is present in the range of about 0.1 to about 0.3 milligrams per kilogram of total feed.

According to a further embodiment, other (non-omega-3) unsaturated fats in the feed are kept below about 9% of the total kcal per kg in the feed. This may result in less variation in omega-3 enrichment between the different muscle groups of the chicken, which have different ratios of muscle tissue to fat tissue, and therefore may reduce the likelihood of off-flavours in any particular muscle group of the chicken.

According to one aspect, the present invention provides an improved enriched chicken product and method for producing enriched chicken products that may serve to address nutritional deficiencies while avoiding negative effects to the taste, colour, texture, aroma, pH and shelf life of the enriched food product which may be significant enough that the enriched chicken product may be unacceptable to consumers.

The present invention may be embodied in other specific forms without departing from the spirit or essential characteristics thereof Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method of feeding a broiler to produce chicken enriched with omega-3 Essential Fatty Acids (EFAs), the method comprising:
feeding a broiler a feed;
wherein the feed comprises marine-sourced docosahexaenoic acid (DHA) and eicosapentaenoic acid (EPA), plant-sourced alpha-linolenic acid (ALA), and organic selenium; and
wherein the feeding provides a sufficient amount of the feed to the broiler until the broiler's total DHA intake is in the range of 0.06 g to 0.25 g, the broiler's total EPA intake is in the range of 0.31 g to 1.30 g, and the broiler's total ALA intake is in the range of 9.36 g to 42.25 g.

2. The method of claim 1, wherein the feeding lasts for about 14 days to about 21 days.

3. The method of claim 1, wherein the feed comprises fish.

4. The method of claim 1, wherein the feed comprises algae.

5. The method of claim 1, wherein the feed comprises flaxseed.

6. The method of claim 1, wherein the feed comprises omega-3 EFAs and omega-6 EFAs, and the feed has a ratio of omega-3 EFAs to omega-6 EFAs in the range of about 1.24:1 to about 1.26:1.

7. The method of claim 1, wherein the feed comprises non-omega-3 unsaturated fats in an amount that is less than about 9% of the feed by calories.

8. A premix for broiler feed comprising:
marine-sourced docosahexaenoic acid (DHA) and eicosapentaenoic acid (EPA);
plant-sourced alpha-linolenic acid (ALA); and
organic selenium.

9. The premix of claim 8, wherein the premix comprises fish.

10. The premix of claim 8, wherein the premix comprises algae.

11. The premix of claim 8, wherein the premix comprises flaxseed.

12. The premix of claim 8, wherein the premix comprises omega-3 EFAs and omega-6 EFAs, and the premix has a ratio of omega-3 EFAs to omega-6 EFAs in the range of about 1.24:1 to about 1.26:1.

13. A method of feeding a broiler and producing chicken products including omega-3 Essential Fatty Acids (EFAs), the method comprising the steps of:
feeding a broiler a feed supplemented with a premix;
wherein the premix comprises marine-sourced docosahexaenoic acid (DHA) and eicosapentaenoic acid (EPA), plant-sourced alpha-linolenic acid (ALA), and organic selenium; and
wherein the feeding provides a sufficient amount of the feed to the broiler until the broiler's total DHA intake is in the range of 0.06 g to 0.25 g, the broiler's total EPA intake is in the range of 0.31 g to 1.30 g, and the broiler's total ALA intake is in the range of 9.36 g to 42.25 g;
slaughtering the broiler when the intake is within the recited ranges; and
processing the broiler into one or more chicken products.

14. The method of claim 13, wherein the chicken products have an enrichment of omega-3 EFAs in the range of about 239.9 to about 472.7 milligrams per 100 grams of total edible meat.

15. The method of claim 13, wherein the feeding lasts for about 14 days to about 21 days.

16. The method of claim 13, wherein the premix comprises fish.

17. The method of claim 13, wherein the premix comprises algae.

18. The method of claim 13, wherein the premix comprises flaxseed.

19. The method of claim 13, wherein the feed comprises non-omega-3 unsaturated fats in an amount that is less than about 9% of the feed as supplemented with the premix by calories.

20. A chicken product produced according to the method of claim 13.
